(19) United States
(12) Patent Application Publication
(10) Pub. No.: US 2014/0152572 A1
(43) Pub. Date: Jun. 5, 2014

(54) ELECTRONIC APPARATUS

(71) Applicant: Kabushiki Kaisha Toshiba, Tokyo (JP)

(72) Inventor: Kentaro TAKEDA, Suginami-ku (JP)

(73) Assignee: Kabushiki Kaisha Toshiba, Tokyo (JP)

(21) Appl. No.: 14/011,554

(22) Filed: Aug. 27, 2013

(30) Foreign Application Priority Data
Nov. 30, 2012 (JP) 2012-261794

(51) Int. Cl. G06F 3/02

(52) U.S. Cl. CPC G06F 3/0202
USPC 345/168

(57) ABSTRACT

According to one embodiment, an electronic apparatus includes: a cabinet having a first surface and a second surface which is opposite to the first surface; a display whose screen is provided in the first surface, configured to display an image; an input unit having an input surface disposed adjacent to the screen, configured to detect an input to the input surface; and plural keys which project from the second surface, height the plural keys being gradually varied from a center line of the second surface toward each of two end portions.

### CROSS REFERENCE TO RELATED APPLICATION(S)

The application is based upon and claims the benefit of priority from Japanese Patent Application No. 2012-261794 filed on Nov. 30, 2012, the entire contents of which are incorporated herein by reference.

### BACKGROUND

1. Field

The present invention relates to an electronic apparatus having a touch screen display and a keyboard.

2. Description of the Related Art

In recent years, electronic apparatus have been developed which is equipped with a touch screen display which detects an input that is made in such a manner that a position on an input surface disposed adjacent to the screen of a display device is specified with a pen, for example.

Among such electronic apparatus are ones in which a touch screen display and a keyboard are provided as separate units which are connected to each other by a hinge mechanism in such a manner that they can be opened and closed.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments. FIG. 1 is a perspective view as viewed from the back side showing the configuration of an electronic apparatus according to a first embodiment of the present invention;

FIG. 2 is a front view showing the configuration of the electronic apparatus;

FIG. 3 is a rear view showing the configuration of the electronic apparatus;

FIG. 4 is a perspective view as viewed from the back side showing how the electronic apparatus is held by hands;

FIG. 5 is a block diagram showing the configuration of a control system of the electronic apparatus;

FIG. 6 is a flowchart showing how the electronic apparatus operates;

FIG. 7 is a perspective view as viewed from the back side showing the configuration of an electronic apparatus according to a second embodiment;

FIG. 8 is a perspective view as viewed from the back side showing the configuration of an electronic apparatus according to a third embodiment; and

FIG. 9 is a perspective view as viewed from the back side showing the configuration of an electronic apparatus according to a fourth embodiment.

### DETAILED DESCRIPTION

According to one embodiment, an electronic apparatus includes: a cabinet having a first surface and a second surface which is opposite to the first surface; a display whose screen is provided in the first surface, configured to display an image; an input unit having an input surface disposed adjacent to the screen, configured to detect an input to the input surface; and plural keys which project from the second surface, height the plural keys being gradually varied from a center line of the second surface toward each of two end portions.

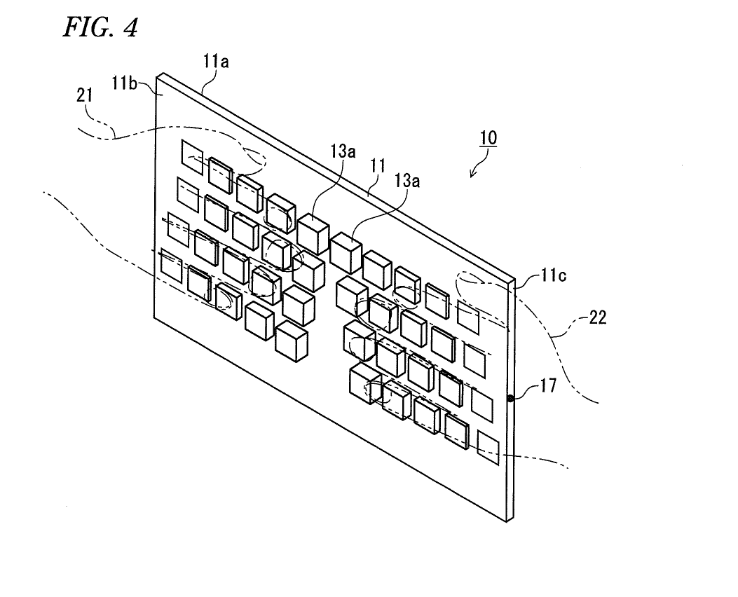

A first embodiment of the present invention will be hereinafter described with reference to the drawings. FIGS. 1-3 are a perspective view, as viewed from the side of a back surface 11b, of a cabinet 11, a front view, and a rear view, respectively, showing the configuration of an electronic apparatus 10 according to the first embodiment. FIG. 4 is a perspective view, as viewed from the side of a back surface 11b, showing how the electronic apparatus 10 is held by hands.

As shown in FIG. 1, the electronic apparatus 10 is equipped with the cabinet 11 which has a front surface 11a as a first surface, the back surface 11b as a second surface which is opposite to the first surface, and holding portions 11c. As shown in FIG. 4, the holding portions 11c are right and left end portions of the cabinet 11 to be gripped (held) by the left hand 22 and the right hand 21 of a user. Each holding portion 11c includes right or left end portions of the front surface 11a and the back surface 11b and the side surface that connects those end portions.

An LCD (liquid crystal display) 12 is disposed so as to be exposed through an opening of the front surface 12a of the cabinet 11. The back surface 11b of the cabinet 11 is provided with plural keys 13b which project from the level of the back surface 11b. As shown in FIG. 4, the user is allowed to make key manipulations by blind touch while looking at the LCD 12 from the front side and holding the electronic apparatus 10 by gripping the holding portions 11c by placing his or her thumbs on the front surface and placing the other fingers on the back surface 11b.

A transparent touch panel 14 is provided on the screen of the LCD 12. In this electronic apparatus 10, the LCD 12 and the touch panel 14 constitute a touch screen display.

The touch screen display has an input surface adjacent to the screen of the LCD 12, and detects a contact area (contact position) on the input surface when it is directly touched by a pen or a finger of the user. This allows the user to perform various manipulations such as selection of a menu bar item or an icon displayed on the screen, input of an instruction, and character input.

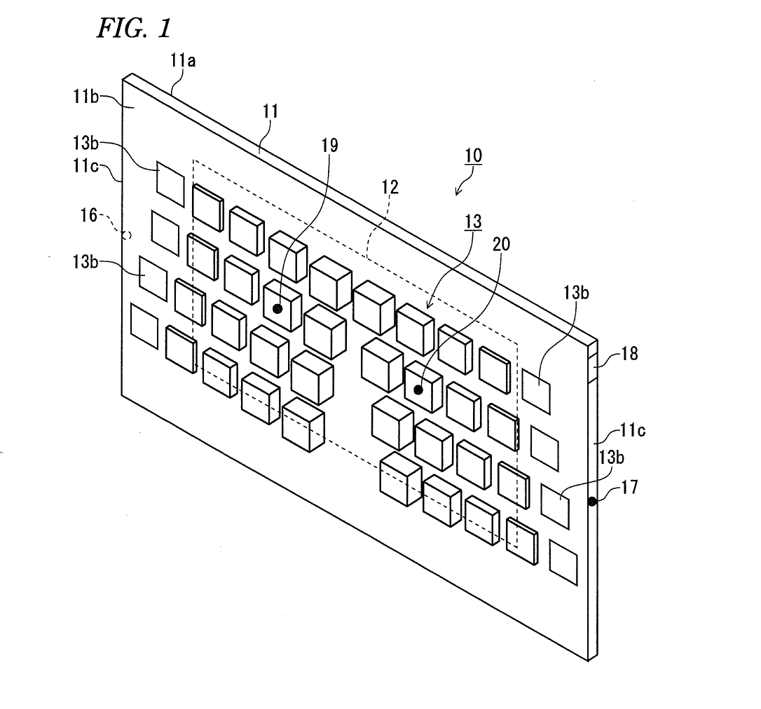

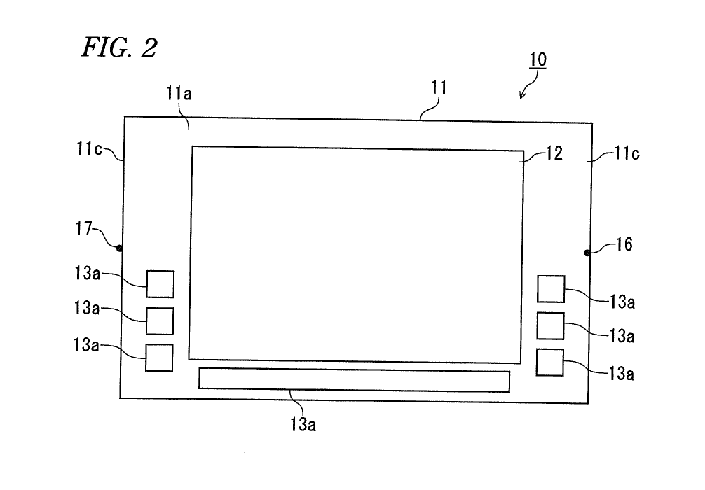

As shown in FIG. 2, plural keys 13a provided on the right of, on the left of, and under the LCD 12 so as to project from the level of the front surface 11a. For example, the keys 13a are a shift key and a control key each of which is required to be pushed simultaneously with another key 13b, a space key which can be manipulated by a thumb, and other kinds of keys. The keys 13a are manipulated by the thumbs of the user. The keys 13a are part of the keys of a keyboard 13.

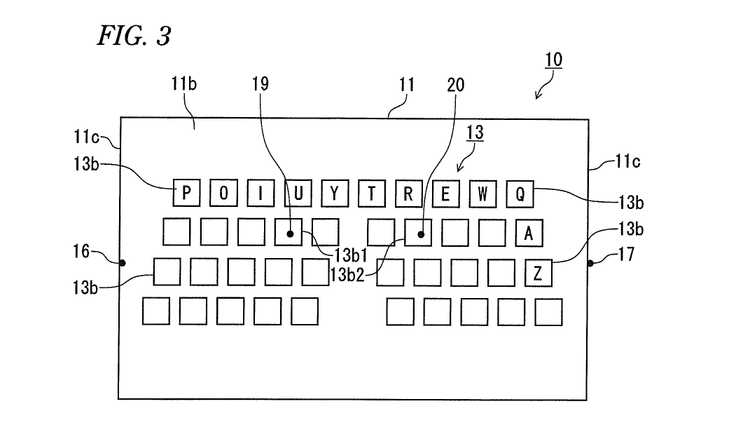

As shown in FIG. 3, the keys 13b which project from the level of the back surface 11b are disposed in such a manner that their height varies (in this example, decreases) gradually as the position goes from the vertical center line of the back surface 11b toward each of its right and left end portions (i.e., the holding portions 11c). As a result, in this example, keys near the vertical center line of the back surface 11b are tall and hence are easier to push with fingers, which lowers the probability of erroneous key manipulations. Furthermore, the probability of touching keys near the right or left end portion with a palm is lowered. The keys 13b are also part of the keys of the keyboard 13.

For example, the keys 13b are character keys, function keys, a ten-key unit, and other keys. For example, the keys 13b are arranged in opposite order to the QWERTY arrangement in the right-left direction. Although in this embodiment the user performs key manipulations with his or her palms opposed to himself or herself, this allows the user to manipulate the keys 13b on the back surface 11b as if he or she could see them.

Furthermore, the keys 13b are arranged in such a manner that the outermost keys 13b gradually come closer to the right and left end portions, respectively, as the position of the row they belong to becomes lower, and that the keys 13b that are adjacent to the vertical center line of the back surface 11b gradually come more distant from the vertical center line as the position of the row they belong to becomes lower. In the embodiment, with this measure, the keys 13b are arranged according to the finger lengths and hence are easier to push with the fingers. In particular, the keys of the lowest row to be manipulated by the little fingers are closer to the holding portions 11c and hence are easier to push, that is, manipulate (see FIG. 4). Still further, the structure that the keys 13a which are required to be pushed simultaneously with one of the keys 13b are provided on the front surface 11a also contributes to increase in the ease of manipulation.

As shown in FIG. 3, the surfaces of particular keys 13b1 and 13b2 among the keys 13b are provided with respective contact sensors 19 and 20, which are, for example, contact pressure sensors capable of detecting a finger contact pressure. In the embodiment, when contact of a finger is detected by the contact sensor 19 or 20, a display indicating the contact is made on the display screen of the LCD 12. As a result, in the embodiment, not only can the particular keys 13b1 and 13b2 which are disposed on the back surface 13b be recognized but also the positions of the other keys 13b which cannot be seen during use can be recognized using the positions of the particular keys 13b1 and 13b2 as references.

The two side surfaces of the cabinet 11 are provided with respective holding sensors 16 and 17 (first and second holding detecting units). Each of the holding sensors 16 and 17 detects holding of the electronic apparatus 10 by the user. More specifically, the holding sensors 16 and 17 detect the hands of the user placed on the side surfaces of the cabinet 11, respectively, by a capacitive method, for example. In the embodiment, data input through the keyboard 13 is made effective when holding of the electronic apparatus 10 by the user is detected by both of the holding sensors 16 and 17.

As shown in FIG. 1, a power switch 18 is provided in the left side surface of the cabinet 11 so as to be exposed. The power switch 18 receives a manipulation for powering on or off the electronic apparatus 10.

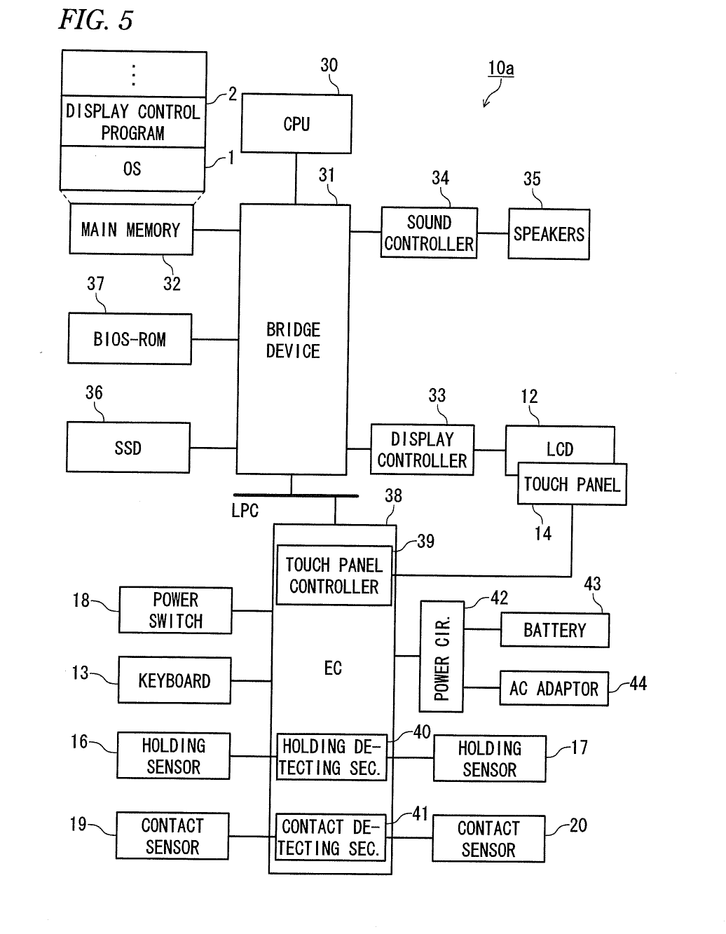

FIG. 5 is a block diagram showing the configuration of a control system of the electronic apparatus 10. As shown in FIG. 5, the electronic apparatus 10 is equipped with a CPU (central processing unit) 30, a bridge device 31, a maim memory 32, a display controller 33, a sound controller 34, speakers 35, an SSD (solid-state drive) 36, a BIOS-ROM (basic input/output system-read only memory) 37, an embedded controller (EC) 38, a power circuit 42, etc.

The CPU 30 is a processor for controlling the operations of individual components of the electronic apparatus 10. The CPU 30 runs an operating system (OS) 1 and various utility/application programs when they are read into the main memory 32 from the SSD 36.

The CPU 30 reads a BIOS from the BIOS-ROM 37 and runs it when, for example, the electronic apparatus 10 is booted or a BIOS read command has been executed. The BIOS is programs for hardware control.

In the embodiment, a display control program 2 is provided as one of the various utility/application programs. The CPU 30 cooperates with the OS 1 to execute a process described by the display control program 2 and thereby perform a display control operation.

The bridge device 31 has a function of communicating with the display controller 33. The display controller 33 is a controller for graphic control which controls the LCD 12, which is the touch screen display of the electronic apparatus 10.

The bridge device 31 incorporates a memory controller for controlling the main memory 32. Furthermore, the bridge device 31 communicates with individual devices on an LPC (low pin count) bus.

The SSD 36 is stored with programs such as the OS 1 and the display control program 2. The main memory 32 is a temporary storage area into which the CPU 30 reads the OS 1, the display control program 2, etc. The CPU 30 controls individual components by reading the OS 1 and the display control program 2 from the SSD 36 and developing them in the main memory 32.

The display controller 33 performs display processing (graphics calculation processing) for drawing display data in a video memory (VRAM; not shown) according to an image drawing request that is input from the CPU 30 via the bridge device 31. Display data corresponding to an image to be displayed on the LCD 12 is stored in the video memory.

When holding of each of the holding portions 11c by the user is detected by a holding detecting section 40, the display controller 33 performs a display control that is enabled by the holding. For example, when holding of both holding portions 11c of the cabinet 11 by the user is detected, the display controller 33 performs a display control corresponding to inputs through the keyboard 13 information input through which has thereby been made possible.

When contact of fingers of the user to the particular keys 13b1 and 13b2 among the keys of the keyboard 13 is detected by a contact detecting section 41, the display controller 33 performs a display control corresponding to the contact. For example, when contact of a finger(s) of the user to one or both of the particular keys 13b1 and 13b2 is detected, the display controller 33 performs a display control corresponding to the contact-detected particular key(s) 13b1 or/and 13b2.

The SSD 36 is stored with various kinds of parameter information relating to display control, which include information (e.g., an icon or text information) to be used when input through the keyboard 13 has been enabled and information (e.g., data relating to positions on the screen of the characters corresponding to the particular keys 13b1 and 13b2) to be used when contact to the particular keys 13b1 and 13b2 has been detected.

When read into the main memory 32 by the CPU 30, the display control program 2 allows the display controller 33 to operate. That is, when holding of the cabinet 11 or contact to the particular key(s) 13b1 or/and 13b2 is detected, the display control program 2 causes a display control using the above-mentioned various kinds of information. The function of the display control program 2 is implemented as an operation of the display controller 33.

The display control program 2 changes parameter information such as a sound volume selected by the user, and informs the OS 1 of a new parameter value. The OS 1 controls the sound controller 34 or the display controller 33 using the parameter value thus received. Such a control makes it possible to change the subtitle size, luminance, sound volume, or picture size.

The embedded controller (EC) 38 has a function of powering on/off the electronic apparatus 10 in response to a manipulation of the power switch 18 by the user. That is, the embedded controller 38 controls the power circuit 42.

The embedded controller 38 has a touch panel controller 39, which controls the touch panel 14 which is provided on the LCD 12. The touch panel controller 39 acquires touch information from a touch sensor and passes it to the CPU 30 via the bridge device 31. Based on the received touch information, the CPU 30 instructs the display controller 33 how to perform a display control.

The embedded controller 38 also has the holding detecting section 40, which acquires detection information from the holding sensors 16 and 17 and performs a control as to the effectiveness of data input through the keyboard 13.

The embedded controller 38 also has the contact detecting section 41, which acquires detection information from the contact sensors 19 and 20 and passes it to the CPU 30 via the bridge device 31. Based on the received detection information, the CPU 30 instructs the display controller 33 how to perform a display control.

The touch panel 14 has a touch sensor of a resistive film type, a capacitive type, or the like. The touch sensor is configured so as to detect a touch area or a touch position on the touch panel 14 (touch screen display).

Where external power is supplied via an AC adaptor 44, the power circuit 42 generates system power to be supplied to the individual components of the electronic apparatus 10 using the external power that is supplied from the AC adaptor 44.

Where no external power is supplied via the AC adaptor 44, the power circuit 42 generates system power to be supplied to the individual components of the electronic apparatus 10 using a battery 43.

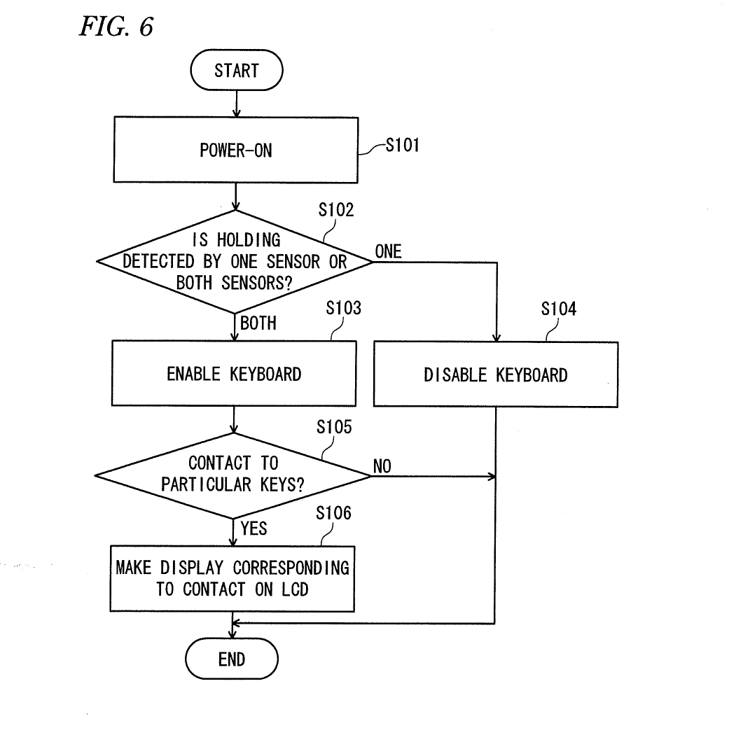

Next, how the electronic apparatus 10 according to the embodiment operates will be described with reference to FIG. 6.

As shown in FIG. 6, after the electronic apparatus 10 was powered on by manipulation of the power switch 18 at step S101, the holding detecting section 40 waits for an event that the hooding sensors 16 and 17 will detect holding of the electronic apparatus 10 by the user. If the electronic apparatus 10 is held by the user, at step S102 the holding detecting section 40 detects whether the electronic apparatus 10 is held by one hand or both hands.

If the holding detecting section 40 detects holding by both hands at step S102, at step S103 the embedded controller 38 enables data input through the keyboard 13.

If the holding detecting section 40 detects holding by one hand at step S102, at step S104 the embedded controller 38 disables data input through the keyboard 13.

If data input through the keyboard 13 is enabled at step S103, at step S105 the contact detecting section 41 detects whether contact to the particular keys 13b1 and 13b2 has occurred.

If the contact detecting section 41 detects contact to the particular keys 13b1 and 13b2 (S105: yes), the embedded controller 38 passes the acquired detection information to the CPU 30 via the bridge device 31. Based on the received detection information, the CPU 30 instructs the display controller 33 how to perform a display control. At step S106, the display controller 33 performs a display control corresponding to a contact-detected particular key(s) 13b1 or/and 13b2.

If only the key 13b1 is contacted by a finger of the user, the display controller 33 displays a character (alphanumeric character, symbol, or the like) corresponding to the key 13b1 in a prescribed display region of the LCD 12. If only the key 13b2 is contacted by a finger of the user, the display controller 33 displays a character (alphanumeric character, symbol, or the like) corresponding to the key 13b2 in a prescribed display region of the LCD 12. If both particular keys 13b1 and 13b2 are contacted by a finger of the user, the display controller 33 displays characters (alphanumeric characters, symbols, or the like) corresponding to the keys 13b1 and 13b2 in prescribed display regions of the LCD 12.

As a result, in the embodiment, when contact to the particular keys 13b1 and 13b2 is detected, not only can the particular keys 13b1 and 13b2 which are disposed on the back surface 13b be recognized but also the positions of the other keys 13b which cannot be seen during use can be recognized using the positions of the particular keys 13b1 and 13b2 as references. That is, the user can recognize the keys 13b disposed on the back surface 13b during use without seeing them and input data by pushing desired keys by blind touch.

It is possible to allow the user to recognize contact to the particular keys 13b1 and 13b2 in the form of a display using LEDs, a sound emitted by the speakers 35, or the like instead of a display of characters corresponding to the particular keys 13b1 and 13b2.

Enablement or disablement of data input through the keyboard 13 may likewise be indicated by displaying characters on the display screen of the LCD 12. Looking at such a display on the display screen, the user can visually recognize enablement or disablement of data input through the keyboard 13.

As described above, in the embodiment, the front surface 11a of the cabinet 11 is provided with the touch screen display, and the keys 13b of the keyboard 13 project from the level of the back surface 11b which is opposite to the front surface 11a so that their height varies (decreases) gradually as the position goes from the vertical center line of the back surface 11b toward each of its right and left end portions. Therefore, the electronic apparatus 10 can be reduced in size and weight so as to allow a user to manipulate it (e.g., make key inputs) while holding it.

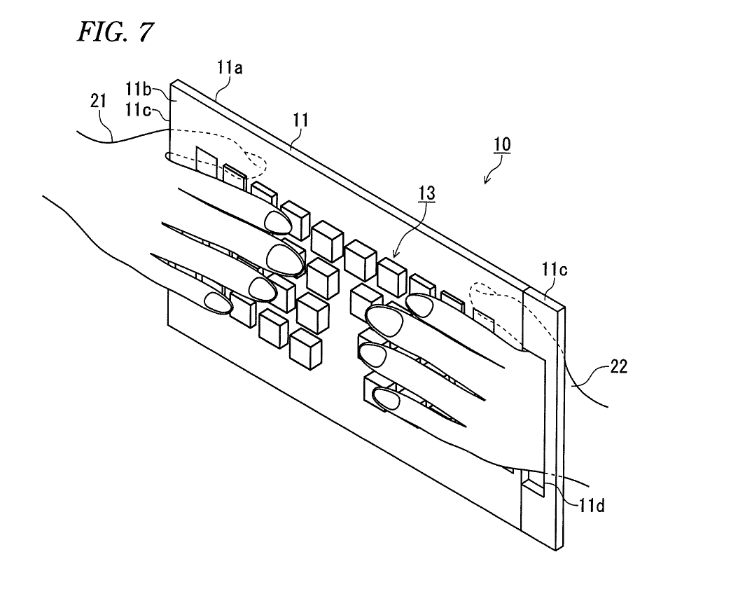

FIG. 7 is a perspective view as viewed from the back side showing the configuration of an electronic apparatus 10A according to a second embodiment.

As shown in FIG. 7, a left holding portion 11c which is a left end portion of the cabinet 11 has a through-hole 11d which opens in the front surface Ha and the back surface 11b. The hole 11d has such a size as to allow insertion of a hand (left hand 22) of the user.

The user inserts his or her left hand 22 through the hole 11d from the side of the front surface 11a and holds the electronic apparatus 10A with the inserted left hand 22. In this state, the user can perform various manipulations such as selection of a menu bar item or an icon displayed on the screen, input of an instruction, and character input by directly touching the input surface with a finger of his or her right hand 21.

Data input through the keyboard 13 is enabled by further gripping the right holding portion 11c with the right hand 21 (i.e., by holding the electronic apparatus 10 with both hands 21 and 22).

This embodiment provides the following advantages in addition to the same advantages as the first embodiment does. As described above, the left holding portion 11c which is an end portion of the cabinet 11 has the through-hole 11d which opens in the front surface 11a and the back surface 11b and allows the left hand 22 of the user inserted through the hole lid to hold the electronic apparatus 10A. As a result, not only can a drop of the electronic apparatus 10 be prevented but also the electronic apparatus 10 can easily be held by one hand (left hand 22). Manipulations on the input surface can be performed smoothly by the other hand (right hand 21).

In this embodiment, when the electronic apparatus 10 is gripped by the left hand 22 which is inserted through the hole 11d, the back of the left hand 22 can be brought into contact with a side surface of the hole 11d. This makes it possible to hold the electronic apparatus 10 more strongly.

Although in this embodiment the hole 11d is formed through the left holding portion 11c, this aspect of the invention is not limited to such a case. The hole 11d may be formed through the right holding portion 11c or both of the left and right holding portions 11c. Where the hole 11d is formed through both of the left and right holding portions 11c, the electronic apparatus 10 can be held even more strongly.

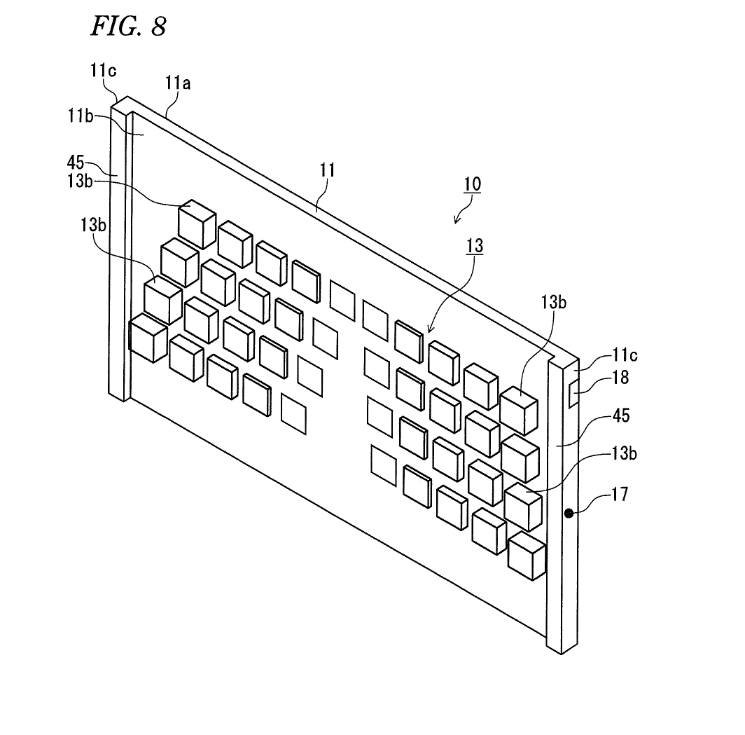

FIG. 8 is a perspective view as viewed from the back side showing the configuration of an electronic apparatus 10B according to a third embodiment.

As shown in FIG. 8, holding portions 11c are provided with holding members 45 which project from the ends of the back surface 11b, respectively. For example, the holding members 45 are thick (tall) and wide enough for the user to grip them with his or her hands.

The keys 13b which project from the level of the back surface 11b are disposed in such a manner that their height increases gradually as the position goes from the vertical center line of the back surface 11b toward each of its right and left end portions (i.e., the holding portions 11c (holding members 45)). It is preferable that the keys closest to the holding members 45 be higher than the holding members 45.

As described above, in this embodiment, since the holding members 45 which are sufficiently tall and wide project from the respective ends of the back surface 11b, the user can grip the electronic apparatus 10 easily and hold it strongly.

This embodiment provides the following advantages in addition to the same advantages as the first embodiment does. In this embodiment, the front surface 11a of the cabinet 11 is provided with the touch screen display, and the height of the keys 13b increases gradually as the position goes from the vertical center line of the back surface 11b which is opposite to the front surface 11a toward each holding member 45. As a result, although the holding members 45 exist at the respective ends of the cabinet 11, the keys 13b can be pushed easily and hence the ease of manipulation of the electronic apparatus 10 can be increased.

Furthermore, in this embodiment, the keys closest to the holding members 45 are higher than the holding members 45.

Therefore, although the holding members 45 project from the respective ends of the back surface 11b, the keys 13b can be pushed more easily and hence the ease of manipulation of the electronic apparatus 10 can be increased further.

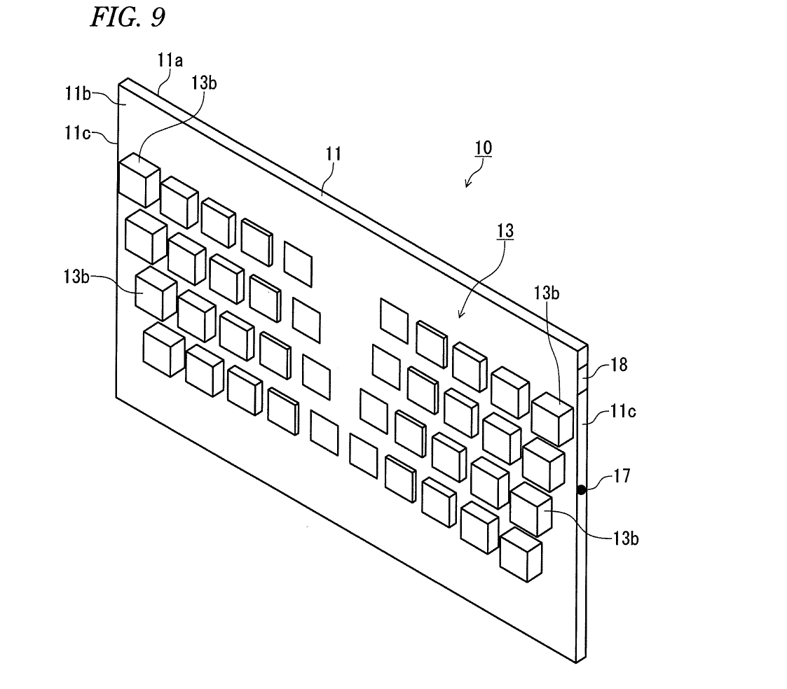

FIG. 9 is a perspective view as viewed from the back side showing the configuration of an electronic apparatus 100 according to a third embodiment.

As shown in FIG. 9, the keys 13b which project from the level of the back surface 11b are disposed in such a manner that their height increases gradually as the position goes from the vertical center line of the back surface 11b toward each of its right and left end portions (i.e., the holding portions 11c).

Furthermore, the keys 13b are arranged in such a manner that the outermost keys 13b gradually come closer to the respective holding portions 11c as the position of the row they belong to becomes higher, and that the keys 13b that are adjacent to the vertical center line of the back surface 11b gradually come more distant from the vertical center line as the position of the row they belong to becomes higher.

The above structures are employed in, for example, a case that the distance between the right and left end portions (holding portions 11c) is so short that keys 13b near the vertical center line of the back surface 11b can be pushed with the fingers bent. Those keys 13b can be pushed properly though they are small in height.

When the hands 21 and 22 are brought into weak contact with the thus-disposed keys 13b, the user can hold the electronic apparatus 10 in such a manner that the keys 13b are covered closely with the hands 21 and 22. The user can hold the electronic apparatus 10 more easily because keys 13b are hooked on the palms and the finger joints.

This embodiment provides the following advantages in addition to the same advantages as the first embodiment does. In this embodiment, the front surface 11a of the cabinet 11 is provided with the touch screen display, and the height of the keys 13b increases gradually as the position goes from the vertical center line of the back surface 11b which is opposite to the front surface 11a toward each holding portion 11c. Furthermore, the keys 13b are arranged in such a manner that the outermost keys 13b gradually come closer to the right and left end portions, respectively, as the position of the row they belong to becomes higher, and that the keys 13b that are adjacent to the vertical center line of the back surface 11b gradually come more distant from the vertical center line as the position of the row they belong to becomes higher. As a result, the keys 13b are hooked on the hands 21 and 22 that are in contact with the keys 13b, whereby the electronic apparatus 10 can be held more easily.

The invention is not limited to the above embodiments themselves and, in the practice stage, may be embodied in such a manner that constituent elements are modified without departing from the spirit and scope of the invention. And various inventive concepts may be conceived by properly combining plural constituent elements disclosed in each embodiment. For example, several ones of the constituent elements of each embodiment may be omitted. Furthermore, constituent elements of different embodiments may be combined as appropriate.

What is claimed is:

1. An electronic apparatus comprising:
a cabinet having a first surface and a second surface which is opposite to the first surface;
a display whose screen is provided in the first surface, configured to display an image;
an input unit having an input surface disposed adjacent to the screen, configured to detect an input to the input surface; and
plural keys which project from the second surface, height the plural keys being gradually varied from a center line of the second surface toward each of two end portions.

2. The electronic apparatus according to claim 1, wherein
the height of the plural keys decreases from the position center line of the second surface toward each of the two end portions.

3. The electronic apparatus according to claim 1, wherein
the height of the plural keys increases from the position center line of the second surface toward each of the two end portions.

4. The electronic apparatus according to claim 1, further comprising
at least one second key which is disposed on the first surface and serves for input of data.

5. The electronic apparatus according to claim 4, wherein
the at least one second key is at least one of a shift key, a control key, and a space key.

6. The electronic apparatus according to claim 1, further comprising:
holding portions which are provided at the two end portions and configured to be held by a user;
first and second holding detecting units configured to detect holding of the respective holding portions by the user; and
an input control unit configured to enable input through the plural keys in a case that the first and second holding detecting units detect holding of the respective holding portions by the user.

7. The electronic apparatus according to claim 6, wherein
at least one of the holding portions has a through-hole which opens in the first surface and the second surface, the through-hole allowing the user to hold the electronic apparatus with a hand inserted through the through-hole.

8. The electronic apparatus according to claim 6, wherein
the holding portions project from the second surface.

9. The electronic apparatus according to claim 1, further comprising:
a contact detecting unit configured to detect contact of a finger of a user to a predetermined one of the plural keys; and
a display control unit configured to display information indicating the contact on the display.

10. The electronic apparatus according to claim 1, wherein:
the two end portions of the second surface correspond to the right and left hands of a user who is to grip the electronic apparatus; and
the plural keys are at least one kind of keys among character keys, function keys, and a ten-key unit, the character keys being arranged in opposite order to the QWERTY arrangement in a direction extending between the two end portions.
